(19) United States
(12) Patent Application Publication
(10) Pub. No.: US 2025/0201825 A1
(43) Pub. Date: Jun. 19, 2025

(54) ALUMINUM ANODE AND NONAQUEOUS ELECTROLYTE SECONDARY BATTERY

(71) Applicant: SUMITOMO CHEMICAL COMPANY, LIMITED, Tokyo (JP)

(72) Inventors: Takitaro YAMAGUCHI, Tsukuba-shi (JP); Shingo MATSUMOTO, Tsukuba-shi (JP); Yuki NAKATA, Tsukuba-shi (JP); Yoshiaki HONDA, Tsukuba-shi (JP); Takashi ARIMURA, Tsukuba-shi (JP)

(21) Appl. No.: 18/849,686

(22) PCT Filed: Mar. 24, 2023
(86) PCT No.: PCT/JP2023/011906

§ 371 Date: Sep. 23, 2024

(30) Foreign Application Priority Data
Mar. 31, 2022 (JP) 2022-060259

(51) Int. Cl. H01M 4/38; H01M 4/02; H01M 4/04; H01M 4/36; H01M 4/62; H01M 10/052; H01M 10/0568

(52) U.S. Cl. CPC H01M 4/38; H01M 4/0435; H01M 4/049; H01M 4/366; H01M 4/625; H01M 4/626; H01M 10/052; H01M 10/0568; H01M 2004/021; H01M 2004/027

(57) ABSTRACT

An aluminum anode used in a nonaqueous electrolyte secondary battery is provided, including an anode body containing aluminum as a material, in which a resistance value in a case where a lithium intercalation capacity is 1 mAh/cm² in a lithium intercalation reaction measured under predetermined measurement conditions is 6.5 kΩ·cm² or less.

### TECHNICAL FIELD

The present invention relates to an aluminum anode and a nonaqueous electrolyte secondary battery.

Priority is claimed on Japanese Patent Application No. 2022-60259, filed on Mar. 31, 2022, the content of which is incorporated herein by reference.

### BACKGROUND ART

As a rechargeable secondary battery, a secondary battery using a nonaqueous electrolyte as an electrolyte (hereinafter, referred to as a nonaqueous electrolyte secondary battery) and a secondary battery using a solid electrolyte as an electrolyte (all-solid secondary battery) are known. Among these, the nonaqueous electrolyte secondary battery has been put into practical use not only for small power sources such as for mobile phone applications and notebook computer applications, but also for medium or large power sources such as for automobile applications and electric power storage applications.

For the nonaqueous electrolyte secondary battery, in order to improve performance, studies on an electrode and an active material contained in the electrode have been conducted. For example, in a lithium secondary battery among the nonaqueous electrolyte secondary batteries, in order to improve battery performance, a study has been conducted on using a material having a theoretical capacity larger than that of graphite, which is an anode material in the related art, for an anode constituting the lithium secondary battery. As such a material, for example, a metal material capable of occluding and releasing lithium ions, the same as graphite, has attracted attention.

As an example of an anode formed of the metal material, for example, Patent Document 1 discloses an anode which is a porous aluminum alloy and is formed of an anode active material for a secondary battery, containing at least one kind of silicon or tin.

### CITATION LIST

### Patent Document

Patent Document 1: Japanese Unexamined Patent Application, First Publication No. 2011-228058

### SUMMARY OF INVENTION

### Technical Problem

As application fields of the nonaqueous electrolyte secondary battery expand, further improvement of the cycle characteristics has been required therefor. There is room for improvement in cycle characteristics of a metal anode used in the nonaqueous electrolyte secondary battery.

The “cycle characteristics” of the nonaqueous electrolyte secondary battery are a performance evaluated by a discharge capacity maintenance rate when charging and discharging are repeated. A case in which the discharge capacity maintenance rate is high when charging and discharging of the nonaqueous electrolyte secondary battery are repeated is evaluated as “favorable cycle characteristics”.

The present invention has been made in view of the above-described circumstances, and an object of the present invention is to provide an aluminum anode for a nonaqueous electrolyte secondary battery which can improve the cycle characteristics thereof; and to provide a nonaqueous electrolyte secondary battery using the same.

### Solution to Problem

The present inventors have analyzed a state of an anode (aluminum anode) as a metal anode containing aluminum as a material in a nonaqueous electrolyte secondary battery, and have examined a cause of deterioration of the anode. As a result, it was found that a coating film which is not initially present is formed on a surface of the anode of the above-described nonaqueous electrolyte secondary battery after performing several cycles of charging and discharging.

The present inventors considered that the above-described coating film inhibits insertion and extraction of Li ions with respect to the aluminum anode, and adversely affects physical properties. The present inventors have intensively studied based on this idea, and have completed the present invention.

That is, in order to achieve the above-described object, one embodiment of the present invention includes the following aspects.
[1] An aluminum anode used in a nonaqueous electrolyte secondary battery, including:
an anode body containing aluminum as a material,
in which a resistance value in a case where a lithium intercalation capacity is 1 mAh/cm² in a lithium intercalation reaction measured under the following measurement conditions is 6.5 kΩ·cm² or less.

### (Measurement Conditions)

current density: 0.6 mA/cm²
cathode: LiCoO₂
electrolyte: 1 mol/L LiPF₆ solution (a mixed solvent of ethylene carbonate
dimethyl carbonate=1:1 (volume ratio))
measurement temperature: 25° C.
C-rate: 0.2 C
[2] The aluminum anode according to [1], further including:
a coating film formed on a surface of the anode body,
in which the coating film contains, as a material, any one selected from the group consisting of gold, carbon, and an alumina hydrate.
[3] The aluminum anode according to [2],
in which a thickness of the coating film is 1 μm or less.
[4] The aluminum anode according to [2] or [3],
in which the coating film contains carbon as a material, and
an oxygen content of the coating film is 20 mol % or less.
[5] The aluminum anode according to [1],
in which the anode body is a rolled material, and
in FT-IR analysis of a surface of the anode body, a rolling oil is equal to or lower than a detection limit.
[6] The aluminum anode according to [5],
in which the anode body is a member in which a surface of a rolled material containing aluminum as a material is treated with either one or both of an alkali treatment and an acid treatment.
[7] The aluminum anode according to any one of [1] to [6],
in which a thickness of a deposit of the electrolyte, which is formed on a surface of the aluminum anode after the lithium intercalation reaction is carried out, is 2 μm or less.
[8] The aluminum anode according to any one of [1] to [7],
in which the anode body contains aluminum and one or more metal elements selected from the group consisting of Si, Ge, Sn, Ag, Sb, Bi, In, Mn, and Mg, and
a content of the metal element with respect to a total amount of the anode body is 0.1% by mass or more and 8% by mass or less.
[9] The aluminum anode according to any one of [1] to [8],
in which an average crystal grain size of an aluminum crystal grain, which is obtained from a scanning ion microscope image of a cross section of the anode body, is 200 μm or less.
[10]A nonaqueous electrolyte secondary battery, including:
a cathode;
the aluminum anode according to any one of [1] to [9]; and a nonaqueous electrolyte.
[11] The nonaqueous electrolyte secondary battery according to [10],
in which the nonaqueous electrolyte contains LiBF₄.
[12]A nonaqueous electrolyte secondary battery, including:
a cathode;
an aluminum anode; and
a nonaqueous electrolyte containing LiBF₄,
in which, in the aluminum anode, a resistance value in a lithium intercalation reaction measured under the following measurement conditions is 6.5 kΩ·cm² or less.

### (Measurement Conditions)

lithium intercalation capacity: 1 mAh/cm²
current density: 0.6 mA/cm²
cathode: LiCoO₂
measurement temperature: 25° C.
C-rate: 0.2 C

### Advantageous Effects of Invention

According to the present invention, it is possible to provide an aluminum anode for a nonaqueous electrolyte secondary battery which can improve the cycle characteristics thereof; and to provide a nonaqueous electrolyte secondary battery using the same.

### BRIEF DESCRIPTION OF DRAWINGS

FIG. 1 is an explanatory diagram showing the ideal behavior during charging and discharging of a lithium secondary battery using an aluminum anode in the related art.

FIG. 2 is an explanatory diagram showing the ideal behavior during charging and discharging of the lithium secondary battery using an aluminum anode in the related art.

FIG. 3 is an explanatory diagram showing the ideal behavior during charging and discharging of the lithium secondary battery using an aluminum anode in the related art.

FIG. 4 is an SEM image showing a state of a surface of an aluminum anode on a cathode side after performing 5 cycles of charging and discharging.

FIG. 5 is an explanatory diagram showing the behavior during charging and discharging of a lithium secondary battery, taking into consideration the formation of a film X.

FIG. 6 is an explanatory diagram showing the behavior during charging and discharging of the lithium secondary battery, taking into consideration the formation of the film X.

FIG. 7 is an explanatory diagram showing the behavior during charging and discharging of the lithium secondary battery, taking into consideration the formation of the film X.

FIG. 8 is a schematic diagram showing an aluminum anode 40A of the embodiment.

FIG. 9 is a schematic diagram showing another aluminum anode 40B according to the embodiment.

FIG. 10 is a schematic diagram showing an example of a nonaqueous electrolyte secondary battery.

### DESCRIPTION OF EMBODIMENTS

### <<Aluminum Anode>>

The aluminum anode according to the present embodiment includes an anode body containing aluminum as a material, in which a lower limit value of a resistance value in a case where a lithium intercalation capacity is 1 mAh/cm² in a lithium intercalation reaction measured under predetermined measurement conditions is preferably 5.8 kΩ·cm² or more, more preferably 5.9 kΩ·cm² or more, and still more preferably 6.0 kΩ·cm² or more. The upper limit value thereof is preferably 6.5 kΩ·cm² or less, and more preferably 6.4 kΩ·cm² or less.

### (Measurement Conditions)

Current density: 0.6 mA/cm²
Cathode: LiCoO₂
Electrolyte: 1 mol/L LiPF₆ solution (a mixed solvent of ethylene carbonate:dimethyl carbonate=1:1 (volume ratio))
Measurement temperature: 25° C.
C-rate: 0.2 C

The above-described resistance value can be calculated from the following expression (1) by using Ohm's law with a voltage (V) of 1 mAh and a current density of 0.6 mA/cm² during charging.

$$Resistance ( Ω \cdot {cm}^{2} ) = Voltage ( V ) of 1 mAh / Current density ( A / {cm}^{2} ) \qquad ( 1 )$$

Hereinafter, the behavior of and the problems with the aluminum anode in the related art will be described, and then the present invention will be described in order.

### (Behavior During Charging of Aluminum Anode in Related Art)

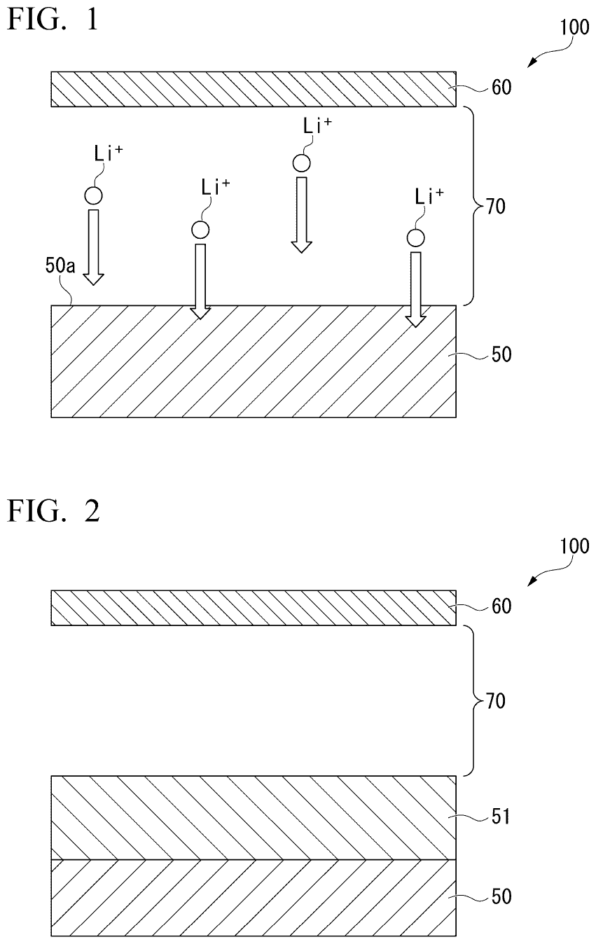

FIGS. 1 to 3 are explanatory diagrams showing the ideal behavior during charging and discharging of a lithium secondary battery (nonaqueous electrolyte secondary battery) 100, in which an aluminum anode 50 in the related art is adopted. The aluminum anode 50 is assumed to be made of aluminum alone.

As shown in FIG. 1, in a case where the lithium secondary battery 100 in which the aluminum anode 50 (hereinafter, anode 50) is adopted is charged, lithium ions (Li ions) move from a cathode 60 side to the anode 50 through an electrolyte 70. The Li ions enter the inside of the anode 50 from a surface 50a of the anode 50 on a side facing the cathode 60, and form an Li—Al alloy. As a result, as shown in FIG. 2, in the anode 50 of the lithium secondary battery 100 after charging, an Li—Al alloy layer 51 grows from the surface 50a in a thickness direction of the anode 50 (normal direction of the surface 50a).

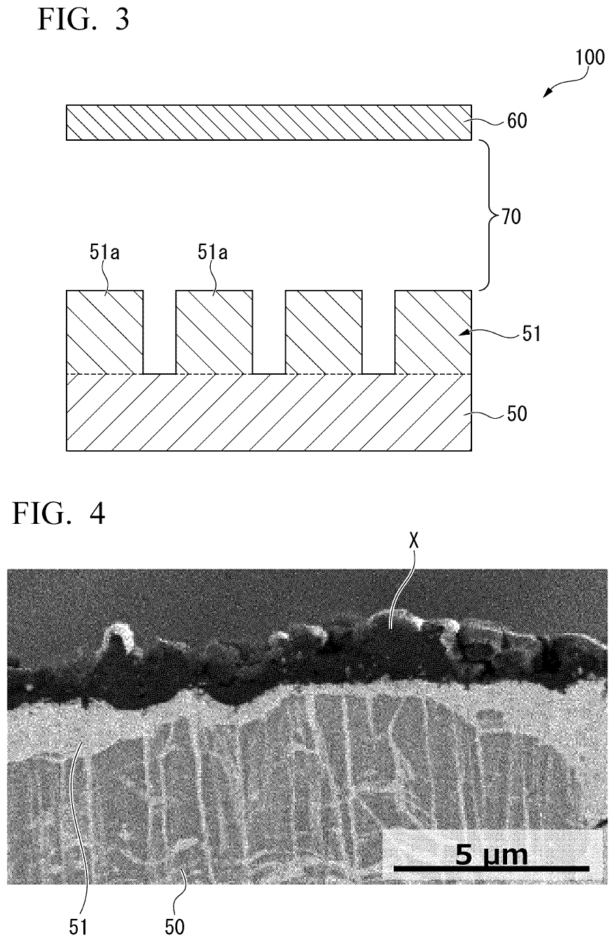

Next, in a case where the lithium secondary battery 100 in a state shown in FIG. 2 is discharged, the Li ions are emitted from the Li—Al alloy layer 51 and inserted into the cathode 60. As a result, the Li—Al alloy layer 51 of the anode 50 is changed to aluminum. In this case, a volume of the Li—Al alloy layer 51 decreases with the release of Li ions. At this time, the Li—Al alloy layer 51 is not uniformly shrunk, and a shrinkage rate is different for each location. As a result, as shown in FIG. 3, cracking occurs on a surface of the Li—Al alloy layer 51, and the surface of the anode 50 after the discharge is in a state in which a plurality of columnar structures 51a are arranged.

Next, in a case where such a lithium secondary battery 100 is re-charged, the Li ions are occluded from a surface of the columnar structure 51a, and the Li—Al alloy layer 51 is formed again. As a result, the columnar structure 51a grows (a volume of the columnar structure 51a increases), and ideally, the cracks generated during the discharge in the anode 50 disappear and the state of FIG. 2 is obtained. As described above, the anode 50 reversibly changes between the charging state shown in FIG. 2 and the discharging state shown in FIG. 3 during the charging and discharging.

However, in the lithium secondary battery adopting the aluminum anode in the related art, it is known that, in a case where the charging and discharging are repeated, the above-described ideal reversible reaction is unlikely to occur, and the aluminum anode gradually collapses. The present inventors analyzed the state of the aluminum anode accompanying the charging and discharging of such a lithium secondary battery, and examined the cause of deterioration of the aluminum anode. As a result, it was found that a coating film which was not initially present was formed on the surface of the aluminum anode after several cycles of charging and discharging.

FIG. 4 is an SEM image (magnification: 10,000 times) showing a state of a surface of the aluminum anode on a cathode side after performing 5 cycles of charging and discharging. From FIG. 4, it can be seen that a film X having a thickness of 1 to 2 μm was formed on the surface of the aluminum anode 50 in contact with the Li—Al alloy layer 51. As a result of the analysis, it was found that a material of the film X is a decomposition product of a solvent such as ethylene carbonate (EC) and dimethyl carbonate (DMC), which is contained in the electrolyte.

In the related art, it is known that, in a case where the lithium secondary battery is charged and discharged, a solid electrolyte interphase (SEI) film is formed on the surface of the anode. Many reports have been made on SEI films in a case where a carbon material is used in the anode, but a thickness of the SEI film known in the related art is in a range of several nm to several tens of nm. On the other hand, the film X shown in FIG. 4 is extremely thick compared with the known SEI film. The present inventors presumed the phenomenon occurring in the aluminum anode, based on the confirmation result of such a film X.

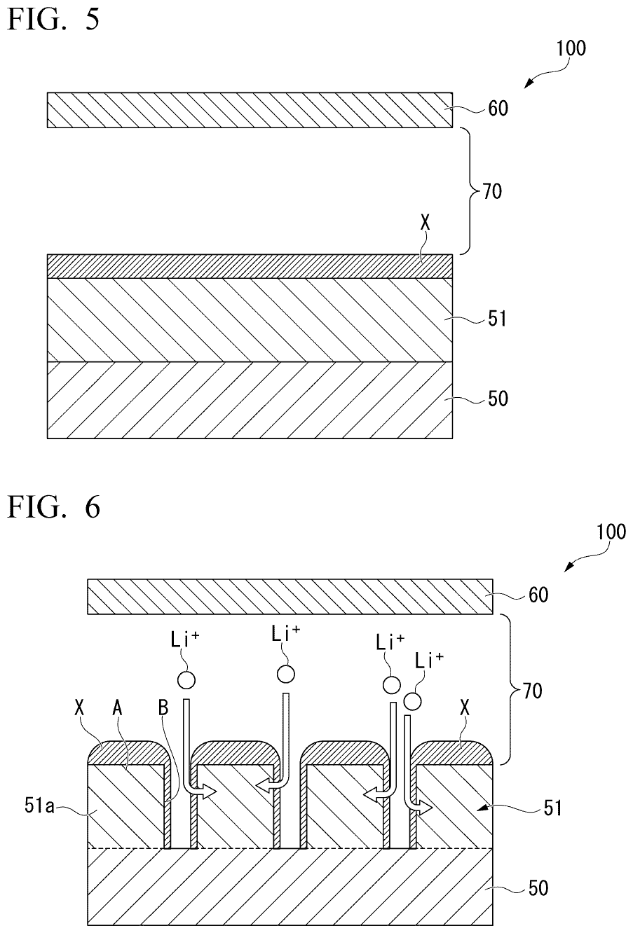

FIGS. 5 to 7 are explanatory diagrams showing the behavior during charging and discharging of the lithium secondary battery 100, taking into consideration the formation of the film X.

As shown in FIG. 5, in the anode 50 of the lithium secondary battery 100 after the first charging, the Li—Al alloy layer 51 grows from the surface 50a in the thickness direction of the anode 50 (normal direction of the surface 1a), and the film X is formed in a state of covering the Li—Al alloy layer 51. In a case where such an anode 50 is discharged, as shown in FIG. 6, the surface of the Li—Al alloy layer 51 is cracked, and is in a state in which a plurality of the columnar structures 51a are arranged. A new surface of the aluminum is generated on the cracked surface (a side surface B of the columnar structure 51a).

The decomposition product which is a material of the film X is also generated in the second or subsequent charging. In consideration of a method of forming the known SEI film, it is considered that the film X is formed by reducing and decomposing the electrolyte on the cathode 60 side of the anode 50, thereby depositing the resulting decomposition product. Therefore, it is assumed that, in the side surface B of the columnar structure 51a close to the cathode 60, the film X is formed to be thicker on a tip end A of the columnar structure 51a than on the side surface B of the columnar structure 51a.

It is assumed that the film X formed of the decomposition product of the electrolyte has a high electrical resistance. Therefore, in a state in which the thick film X is formed at the tip end A in this way, in a case where the lithium secondary battery 100 is further charged, the Li ions enter the inside of the columnar structure 51a from the side surface B of the film X, which is relatively thinner than the tip end A and has a low electrical resistance, and form an Li—Al alloy.

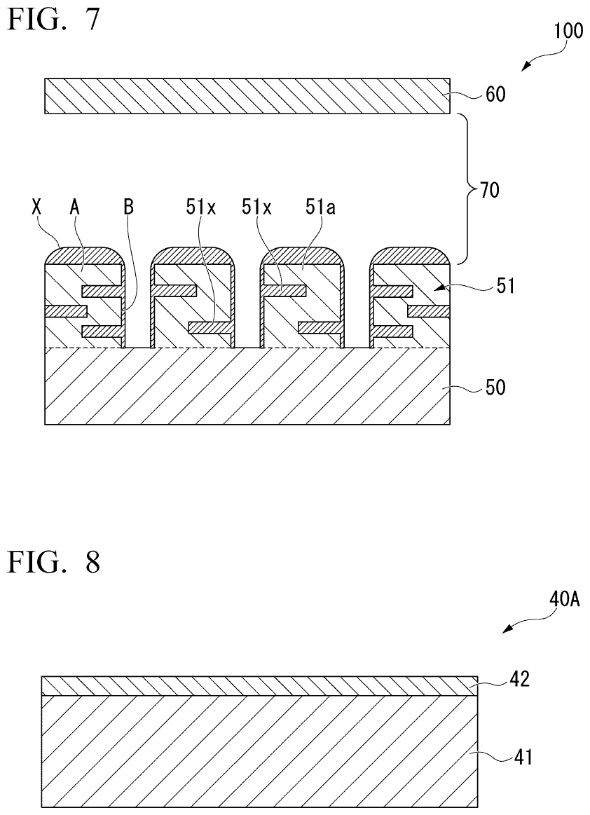

As a result, the side surface B is an intrusion surface of the Li ions to the anode 50, and as shown in FIG. 7, it is assumed that the “cracks on the intrusion surface of the Li ions” occur on the side surface B, and a crack 51x is formed in the columnar structure 51a. In a case where the crack 51x grows, the columnar structure 51a is cut from the crack 51x, and as a result, it is assumed that the anode 50 collapses and deteriorates.

The present inventors studied the assumed deterioration mechanism of the anode as described above, and presumed that the cause of the deterioration of the aluminum anode is the film X formed to be extremely thick compared with the known SEI film. In addition, in a case where the formation of the film X can be suppressed, it is considered that the deterioration of the aluminum anode can be suppressed, and the present inventors conducted studies to complete the present invention.

Since it is assumed that the electrical resistance is increased compared with the anode body by the formation of the film X, in the present invention, the effect of “suppression of the formation of the film X” is determined by the resistance value of the lithium intercalation reaction described above. The resistance value of the lithium intercalation reaction is obtained in detail as follows.

### (Method for Measuring Resistance Value of Lithium Intercalation Reaction)

### (1) Manufacture of Lithium Secondary Battery

First, as a measurement target, an aluminum anode having a thickness of 50 μm is cut out into a disk shape having a diameter of φ16 mm.

Next, LiCoO₂ is molded into a disk shape having a diameter of φ14 mm, and used as a counter electrode (cathode).

Next, an electrolyte is produced by dissolving LiPF₆ in a mixed solvent obtained by mixing ethylene carbonate (EC) and dimethyl carbonate (DMC) at EC:DMC=50:50 (volume ratio) with a ratio of 1.0 mol/L.

A polyethylene porous separator is disposed between the aluminum anode and the counter electrode, and the separator is accommodated in a battery case (standard 2032). The above-described electrolyte is injected into the battery case, and then the battery case is sealed to manufacture a coin-type (half-cell) lithium secondary battery having a diameter of 20 mm and a thickness of 3.2 mm.

### (2) Measurement of Resistance Value of Lithium Intercalation Reaction

The coin-type lithium secondary battery is allowed to stand at room temperature (25° C.) for 10 hours, thereby sufficiently impregnating the cathode and the separator with the electrolyte. Next, the battery is charged at a current density of 0.6 mA/cm² and 0.2 C at room temperature (25° C.), and a charging curve is created with the charging capacity (unit: mAh) on the horizontal axis and the voltage (unit: V) on the vertical axis.

In the obtained charging curve, a voltage at 1 mAh is read, and a resistance value obtained from Ohm's law (V=IR) is used as the resistance value of the lithium intercalation reaction.

In the aluminum anode according to the embodiment of the present invention, the formation of the film X is suppressed by performing each treatment described later. In a case where the resistance value in the lithium intercalation reaction of the obtained aluminum anode was 6.5 kΩ·cm² or less, it can be determined that the formation of the film X is suppressed, and improvement in cycle characteristics (maintenance rate of a discharge capacity) can be expected with the suppression of the deterioration of the aluminum anode.

The maintenance rate of the discharge capacity is measured by the following method. The favorable cycle characteristics mean that the maintenance rate of the discharge capacity, measured by the following method, is 80% or more and 100% or less.

### (Method for Measuring Maintenance Rate of Discharge Capacity)

An initial charging and discharging are carried out, using the lithium secondary battery manufactured according to the (1) Manufacture of lithium secondary battery described above, by performing a constant current charging at 1 mA up to 4.2 V at room temperature and performing a constant current-constant voltage charging at 4.2 V over 5 hours, and then performing a constant current discharging at 1 mA up to 3.4 V. A discharge capacity is measured, and the obtained value is defined as “initial discharge capacity” (mAh), that is, the discharge capacity in the first cycle.

After the first charging and discharging, the charging and discharging are repeated as one cycle of charging at 1 mA and discharging at 1 mA, under the same conditions as the first charging and discharging. A discharge capacity is measured in each cycle, and the discharge capacity maintenance rate is obtained as a ratio to the initial discharge capacity.

The maximum value of the number of cycles in which the discharge capacity maintenance rate is 80% or more with respect to the initial discharge capacity is obtained for evaluation. It is determined that the cycle characteristics are more favorable as the obtained “maximum value of the number of cycles” increases.

### (Aluminum Anode)

Next, a specific configuration for realizing the aluminum anode having a resistance value of the lithium intercalation reaction of 6.5 kΩ·cm² or less will be described. In the present invention, the aluminum anode having a resistance value of the lithium intercalation reaction of 6.5 kΩ·cm² or less is realized by suppressing the formation of the film X as described above.

FIG. 8 is a schematic diagram showing an aluminum anode 40A of the present embodiment. The aluminum anode 40A includes an anode body 41 and a coating film 42 formed on a surface of the anode body 41. In FIG. 8, it is presumed that the coating film 42 is formed on one surface of the anode body 41, but the coating film 42 may be formed on both surfaces of the anode body 41.

### (Anode Body)

The anode body 41 acts as an anode active material in the nonaqueous electrolyte secondary battery. The anode body 41 may contain only aluminum as a material, except for impurities inevitably contained (inevitable impurities). In addition, as the anode body 41, an aluminum alloy which contains aluminum as a base material and is manufactured by intentionally adding other metals (non-aluminum metals) may be used as the material.

As the inevitable impurities, manufacturing residues which are inevitably mixed in a refining step are exemplary examples. Specifically, iron and copper are exemplary examples. A content of the inevitable impurities is 0.1% by mass or less, preferably 0.05% by mass or less and more preferably 0.01% by mass based on the entire base material.

As the aluminum material of the anode body 41, aluminum having a purity of 99.9% by mass or more, high-purity aluminum having a purity of 99.99% by mass or more, or the like can be used. High-purity aluminum can be manufactured by appropriately adopting a known method such as a segregation method, a three-layer electrolysis method, a belt melting purification method, and an ultra-high vacuum solubility method, as a manufacturing method for increasing the purity of aluminum.

It is preferable that the aluminum alloy have a phase of aluminum (aluminum metal phase) in which a phase of the above-described other metals (non-aluminum metal phase) is dispersed. That is, in the aluminum alloy, it is preferable that the non-aluminum metal phase be dispersed and present in the aluminum metal phase.

In the non-aluminum metal phase, it is preferable that the above-described other metals be aggregated in particles and dispersed throughout the aluminum metal phase. The expression “in particles” is used for expressing a state in which the non-aluminum metal phase appears to be aggregated roundly for forming particles, in a case where a surface or cross section of the aluminum-containing metal is observed.

The non-aluminum metal phase means a metal phase not containing aluminum. It is preferable that the non-aluminum metal phase be composed of one or more metal elements selected from the group consisting of Si, Ge, Sn, Ag, Sb, Bi, In, Mn, and Mg. A content of the metal element with respect to the total amount of the anode body 41 is preferably 0.1% by mass or more and 8% by mass or less. The content of the metal element with respect to the total amount of the anode body 41 is more preferably 2.0% by mass or less and still more preferably 1.0% by mass or less.

The above-described “other metals” constituting the non-aluminum metal phase have an extremely large amount of lithium occlusion. Therefore, the non-aluminum metal has a large volume expansion during lithium intercalation and a large volume contraction during lithium deintercalation. Distortion generated by the expansion and contraction of the non-aluminum metal may develop into cracking in a structure made of the non-aluminum metal (for example, the anode), and as a result, the structure made of the non-aluminum metal may be miniaturized. The miniaturization of the non-aluminum metal acting as an anode active material during charging and discharging causes a shortened cycle life.

On the other hand, in a case where the non-aluminum metal phase is dispersed in the aluminum metal phase as described above, it is presumed that the aluminum, which expands relatively less in volume than the non-aluminum metal, covers the periphery of the particulate non-aluminum metal. Therefore, in the anode in which the non-aluminum metal phase is dispersed in the aluminum metal phase, the expansion causing the miniaturization of the non-aluminum metal is easily suppressed. Accordingly, it is easy to maintain the initial discharge capacity even in a case where the charging and discharging of the lithium secondary battery are repeated.

### (Method for Measuring Content of Metal Element)

The content of the metal element can be obtained using an optical emission spectrometer (model: ARL-4460, manufactured by Thermo Fisher Scientific) to quantify the amount of the metal element in the aluminum. The metal element can be quantified more accurately using a glow discharge mass spectrometer.

As the metal element constituting the non-aluminum metal phase, a metal element having few inevitable impurities is suitably used. For example, in a case where Si is used as the metal element, as the material, high-purity silicon having a purity of 99.999% by mass or more is used.

In a case where the anode body 41 is made of an alloy in which the non-aluminum metal phase is dispersed in the aluminum metal phase, the anode body 41 is obtained by casting an alloy molten metal of the aluminum and a metal element constituting the non-aluminum metal phase, and then performing cutting, rolling, extrusion, forging, or the like on a casting piece of the obtained alloy.

The anode body 41 preferably contains an aluminum crystal grain. An average crystal grain size of the aluminum crystal grain is preferably 200 μm or less. The average crystal grain size of the aluminum crystal grain is a value calculated from a scanning ion microscope (SIM) image of a cross section of the anode body 41.

In a case where the anode body 41 is made of the above-described aluminum alloy, it is preferable that the aluminum metal phase be composed of the aluminum crystal grain.

The cross-sectional SIM observation of the anode body 41 can be performed by the following method.

### (Method for Measuring Average Crystal Grain Size)

First, the aluminum anode in a non-charged state is processed with the following focused ion beam processing observation device to produce a cross section of the anode body 41. Next, the obtained cross section is observed using the following focused ion beam processing observation device.

### [Measurement Conditions]

Focused ion beam processing observation device: FB-2100 (manufactured by Hitachi High-Technologies Corporation)
Ion source: gallium liquid metal
Acceleration voltage: 40 kV
Magnification: 700 times to 50,000 times

The average crystal grain size of the aluminum crystal grain is obtained by the following method.

Among crystal grains included in the SIM image obtained by the above-described method, for all crystal grains in which the entire periphery of the contour can be confirmed, a distance (constant direction diameter) between parallel lines drawn in a certain direction and sandwiching each crystal grain is measured. An arithmetic average value of the obtained measured values is defined as the average crystal grain size of the crystal grain.

In a case where lithium is occluded in the anode body 41, the aluminum crystal grain is changed to a Li—Al alloy particle, and a volume of the crystal grain is increased. In a case where the volume of the crystal grain is increased, distortion may occur in a crystal lattice in the periphery of the crystal grain. In such a portion where the crystal lattice is distorted, Li is likely to enter the crystal lattice.

On the other hand, in a case where the average crystal grain size of the aluminum crystal grain is 200 μm or less, the volume increase of each of the plurality of crystal grains is also small, and it is difficult to form the distortion around the crystal grains. Therefore, it is difficult for a difference in the ease of intrusion of Li, that is, ease of forming the Li—Al alloy to occur in the anode body 41, and it is difficult for the Li—Al alloy to be formed with deviation. As a result, deformation such as wrinkles and cracks is less likely to occur in the aluminum anode during the charging and discharging, and the deterioration can be suppressed.

The average crystal grain size of the aluminum crystal grain is preferably 200 μm or less, more preferably 100 μm or less, still more preferably 50 μm or less, and particularly preferably 10 μm or less. The lower limit thereof is preferably 1 μm or more and more preferably 3 μm or more.

Any one of the upper limit values and any one of the lower limit values of the average crystal grain size of the aluminum crystal grain can be combined.

### (Vickers Hardness)

In addition, a Vickers hardness of the anode body 41 is preferably 10 HV or more and 100 HV or less. The Vickers hardness of the anode body 41 is more preferably 10 HV or more and 70 HV or less, still more preferably 20 HV or more and 70 HV or less, and even more preferably 30 HV or more and 70 HV or less.

As the Vickers hardness, a Vickers hardness (HV: 0.05) measured by the following method using a micro Vickers hardness meter is used.

### (Method for Measuring Vickers Hardness)

The Vickers hardness is a value measured according to JIS Z2244: 2009 “Vickers hardness test—Test method”. The Vickers hardness is measured by pushing a square pyramid-shaped diamond indenter into a surface of a test piece of the anode body 41, releasing a test force thereof, and then calculating a Vickers hardness from a diagonal length of a dent remaining on the surface. In a case where the anode body 41 is not exposed on the surface of the aluminum anode 40A, the measurement may be performed on the anode body 41 exposed after appropriately removing the coating film 42.

The above-described standard stipulates that a hardness symbol is changed according to the test force. In the present embodiment, a Micro Vickers hardness of HV 0.05 in a case where the test force is set to 0.05 kgf (=0.4903 N) is measured.

It is presumed that, in a case where the Vickers hardness is equal to or less than the above-described upper limit value, strain in the crystal structure during occlusion of the lithium by the aluminum can be relaxed, and the crystal structure can be maintained. Therefore, the aluminum anode 40A can maintain the discharge capacity even in a case where the aluminum anode 40A is adopted in the lithium secondary battery and is repeatedly charged and discharged.

### (Coating Film)

The coating film 42 contains, as a material, any one selected from the group consisting of gold, carbon, and an alumina hydrate. All of the materials of the coating film 42, that is, the gold, carbon, and alumina hydrate, have lithium ion conductivity.

In a case where the material of the coating film 42 is gold, the coating film 42 can be formed by physically depositing gold on the surface of the anode body 41.

In a case where the coating film 42 made of gold is formed on the surface of the anode body 41, it is predicted that a decomposition product of an organic substance is unlikely to adhere to the surface of the coating film 42. Therefore, it is considered that the decomposition product of the electrolyte, which is the material of the film X, is less likely to be deposited, and the formation of the film X is suppressed.

That is, with the aluminum anode including the anode body made of aluminum and the coating film made of gold and formed on the surface of the anode body, the coating film made of gold suppresses the decomposition of the electrolyte, and the formation of the film X. As a result, it is considered that, with such an aluminum anode, an aluminum anode having a resistance value of the lithium intercalation reaction, measured under the above-described measurement conditions, of 6.5 kΩ·cm² or less can be obtained.

In a case where the material of the coating film 42 is carbon, the coating film 42 can be formed by depositing carbon on the surface of the anode body 41. The method of the deposition may be a chemical deposition or a physical deposition.

In addition, in a case where the material of the coating film 42 is carbon, an oxygen content of the coating film 42 is preferably 20 mol % or less, more preferably 15 mol % or less, still more preferably 10 mol % or less, and even more preferably 5 mol % or less. The oxygen content in the coating film 42 is ideally 0 mol % or more, and may be 0.1 mol % or more.

### (Method for Measuring Oxygen Content)

The oxygen content can be measured by calculating a molar ratio of each element included in the coating film 42 by X-ray photoelectron spectroscopy (XPS) analysis. An XPS spectrum of the coating film 42 is acquired, and using XPS data analysis software, a molar ratio (mol %) of each element constituting the coating film 42 can be calculated by multiplying an area value of a peak derived from each element by a relative sensitivity coefficient of the device. The oxygen content is an oxygen proportion (mol %) in a case where the content of all elements detected by the XPS analysis is expressed as a molar ratio (mol %).

### [Measurement Conditions]

Device: Quantera SXM (manufactured by ULVAC-PHI, INCORPORATED.)
X-ray source: Al-Kα ray
Photoelectron take-off angle: 45 degrees
Aperture diameter: 100 μm
Static neutralization: none

### [Analysis Conditions]

Analysis software: MuitiPak (manufactured by ULVAC-PHI, INCORPORATED.)

The composition of the electrolyte is usually adjusted assuming that the anode is graphite. Therefore, in a case where the surface to which the decomposition product (film X) of the electrolyte adheres is covered with carbon, it can be expected that, compared with a case in which the decomposition product of the electrolyte adheres directly to the anode body made of aluminum, the film X having favorable Li ion conductivity is likely to be formed, and an increase in resistance value due to the film X is less likely to occur.

That is, with the aluminum anode including the anode body made of aluminum and the coating film made of carbon and formed on the surface of the anode body, by using an electrolyte optimized for a carbon-based anode, it is also difficult to form the film X with abnormal thickness. As a result, it is considered that, with such an aluminum anode, an aluminum anode having a resistance value of the lithium intercalation reaction, measured under the above-described measurement conditions, of 6.5 kΩ·cm² or less can be obtained.

In a case where the material of the coating film 42 is an alumina hydrate (Al₂O₃·nH₂O), the coating film 42 can be formed by immersing the anode body 41 in hot water at 50° C. to 100° C. for several minutes to several hours. Such a forming method is known as a boehmite method. The term “boehmite method” has the meaning defined in JIS H 0201: 1998 “Glossary of Terms Used in the Surface Treatment of Aluminum”. In the above-described immersion treatment, ammonia or triethanolamine may be added to the hot water as necessary. With these additives, the alumina hydrate can be uniformly generated, and a homogeneous coating film 42 can be formed. The alumina hydrate is also called bayerite or alumina hydrate, depending on the amount of hydrate, and it is known that the amount can be controlled by the temperature of the hot water and the immersion time.

In addition, the coating film 42 made of the alumina hydrate can also be formed by blowing high-temperature steam onto the anode body 41.

The alumina hydrate film formed on the surface of the anode body 41 and a naturally oxidized film on the surface of the anode body 41 can be distinguished from each other by observing the surface with a microscope. The alumina hydrate film can be observed by enlarging the observation by 10,000 times. On the other hand, since the naturally oxidized film is so thin that it cannot be observed at the above-described magnification, the naturally oxidized film can be easily distinguished from the above-described alumina hydrate film.

In a case where the electrolyte is decomposed on the surface of the anode 40A, it is considered that the electrolyte in contact with the surface of the anode 40A is supplied with electrons from the anode 40A, and is reduced and decomposed. On the other hand, the alumina hydrate film is in an electrically immobilized state and is difficult for electrons to pass through. Therefore, in a portion on the surface of the anode 40A, covered with the alumina hydrate film, it is considered that the transfer of electrons between the electrolyte and the anode 40A is unlikely to occur, and the reduction and decomposition of the electrolyte is unlikely to occur.

That is, with the aluminum anode including the anode body made of aluminum and the coating film made of the alumina hydrate and formed on the surface of the anode body, the reduction and decomposition of the electrolyte on the surface is unlikely to occur, and the film X is also less likely to form. As a result, it is considered that, with such an aluminum anode, an aluminum anode having a resistance value of the lithium intercalation reaction, measured under the above-described measurement conditions, of 6.5 kΩ·cm² or less can be obtained.

A thickness of the coating film 42 is preferably 1 μm or less and more preferably 0.5 μm or less. In a case where the thickness of the coating film 42 is 1 μm or less, during the charging and during the discharging, the Li ions are likely to be suitably transmitted through the coating film 42 without hindering the movement of the Li ions. As a result, the battery performance can be improved. In a case of being 1 μm or less, the thickness increase in the battery manufacturing is almost suppressed, and the decrease in capacity can be suppressed. The thickness of the coating film 42 is preferably 100 nm or more, and more preferably 200 nm or more.

In a case where the material of the coating film 42 is carbon, the thickness of the coating film 42 is preferably 1 nm or more and 1 μm or less, and more preferably 1 nm or more and 100 nm or less.

### (Method for Measuring Thickness of Coating Film)

The thickness of the coating film 42 is measured from a cross-sectional SEM image after a cross section of the coating film 42, perpendicular to the surface of the coating film 42, is formed on the surface of the aluminum anode 40A. For example, the cross section is observed at a magnification of 10,000 times, and a virtual line connecting an intersection between an outer frame in an enlarged field of view and the surface of the coating film 42 is set as a reference line. Next, a perpendicular line is extended from a reference point set on the reference line toward the anode body 41, and an intersection between the “interface between the anode body 41 and the coating film 42” and the “perpendicular line” is set. Next, a length of a line segment connecting the intersection point and the reference point is obtained. On the surface of the coating film 42, 10 reference points are set at equal intervals in one enlarged field of view, the length of the line segment is obtained at each reference point as described above, and an arithmetic average value of the obtained lengths is defined as the thickness of the coating film 42.

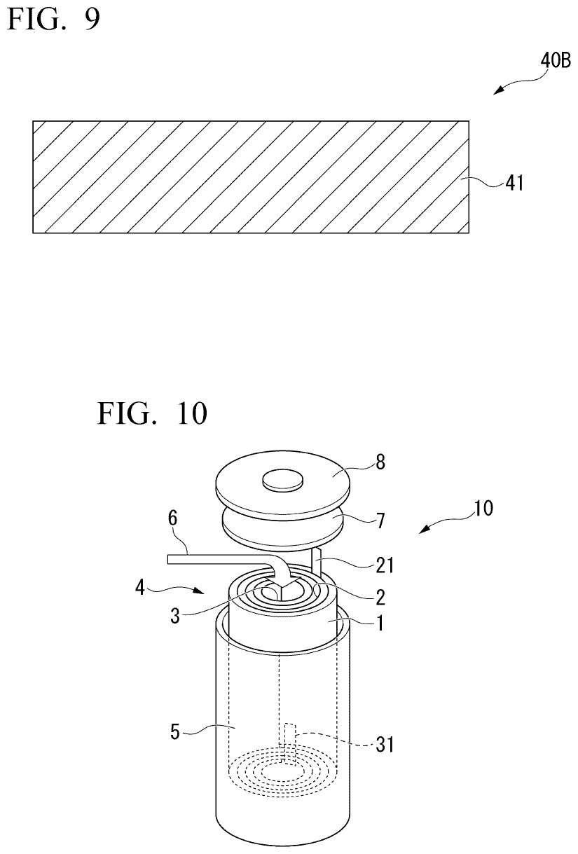

FIG. 9 is a schematic diagram showing another aluminum anode 40B according to the present embodiment. The aluminum anode 40B consists of only an anode body 41. The anode body 41 is the same as the anode body described above.

In the aluminum anode 40B, the surface is treated in advance with an alkali and an acid. Specifically, the anode body 41 is immersed in an alkali (5% by mass of NaOH aqueous solution) at 60° C. for 30 seconds, immersed in an acid (30% by mass of HNO₃ aqueous solution) at 25° C. for 30 seconds, and then washed with water to obtain the aluminum anode 40B.

A naturally oxidized film which is aluminum oxide is formed on a surface of the anode body 41 (a surface of a rolled material of aluminum which is a material of the anode body 41). It is considered that aluminum oxide existing as the naturally oxidized film catalyzes and promotes the reduction and decomposition of the electrolyte.

In addition, a surface of the rolled material of aluminum, which is a material of the anode body 41, may be adhered with oil (rolling oil) used during rolling in a case of manufacturing the rolled material.

By subjecting the material (rolled material) of the anode body 41 to the alkali and acid treatments, a film of an organic compound (typically, the rolling oil) or a naturally oxidized film, which adheres to the surface of the rolled material, can be removed, and an electric resistance value on the surface can be reduced. The fact that the rolling oil is removed can be confirmed by performing FT-IR analysis on the surface of the anode body 41 and detecting the rolling oil to be equal to or lower than the detection limit.

That is, with the member in which the surface of the rolled material made of aluminum is treated with either one or both of the alkali treatment and the acid treatment, for example, with the aluminum anode in which the surface of the rolled material is treated with alkali and acid in this order, it is assumed that the film of an organic compound or the naturally oxidized film is not present. Therefore, a catalytic reaction caused by the film of the organic compound or the naturally oxidized film is suppressed, and the reduction and decomposition of the electrolyte is suppressed. As a result, the film X is less likely to be formed. As a result, it is considered that, with such an aluminum anode, an aluminum anode having a resistance value of the lithium intercalation reaction, measured under the above-described measurement conditions, of 6.5 kΩ·cm² or less can be obtained.

Such an aluminum anode can be manufactured by a manufacturing method of an aluminum anode, including a step of manufacturing a rolled material using aluminum as a material, and a step of treating a surface of the rolled material with the alkali treatment and/or the acid treatment.

In addition, the surface of the rolled material may be subjected to a non-chromate treatment after being treated with either one or both of the alkali treatment and the acid treatment. By performing the non-chromate treatment, the natural oxide film is suppressed from being formed on the surface of the rolled material, treated with the alkali treatment or the acid treatment. As a non-chromate treatment liquid, an inorganic system may be selected from a Zr system, a Ti system, an Mo system, an Mn system, or a Ce system; and an organic system may be selected from a silane coupling agent.

In the aluminum anodes 40A and 40B, after the lithium intercalation reaction is carried out by the above-described method, it is preferable that the thickness of the film X (deposit of the electrolyte) formed on the surface of the aluminum anode is 2 μm or less. In a case where the formed film X is thin, the deterioration of the columnar structure 51a as described in FIGS. 6 and 7 is less likely to occur.

The thickness of the film X is preferably 1 μm or less, more preferably 0.1 μm or less, and still more preferably 0.01 μm or less. After the lithium intercalation reaction is carried out, the thinner the film X formed on the surface of the aluminum anode is, the less likely (it is) for the surface resistance of the anode to increase, and the more likely (it is) for the performance of the anode to be maintained. The thickness of the film X is ideally 0 nm, and may be 5 nm or more.

### (Method for Measuring Thickness of Deposit)

The thickness of the film X (deposit) can be measured by the same method as in (Method for measuring thickness of coating film) described above, except that the measurement target is changed from the coating film 42 to the film X.

With the aluminum anode having the above-described configuration, an aluminum anode for a nonaqueous electrolyte secondary battery which can improve the cycle characteristics thereof is provided.

### <<Nonaqueous Electrolyte Secondary Battery>>

FIG. 10 is a schematic diagram showing an example of the nonaqueous electrolyte secondary battery. A lithium secondary battery (nonaqueous electrolyte secondary battery) 10 includes a cathode 2, an aluminum anode (anode) 3, and a nonaqueous electrolyte (electrolyte solution) 6.

The cylindrical lithium secondary battery 10 is produced as described below. First, as shown in FIG. 10, a pair of separators 1 having a strip shape, a strip-shaped cathode 2 having a cathode lead 21 at one end, and a strip-shaped anode 3 having an anode lead 31 at one end are laminated in order of the separator 1, the cathode 2, the separator 1, and the anode 3, and wound to form an electrode group 4.

Next, the electrode group 4 and an insulator (not shown) are accommodated in a battery can 5, and a can bottom is sealed. The electrode group 4 is impregnated with an electrolyte solution 6, and an electrolyte is disposed between the cathode 2 and the anode 3. Furthermore, an upper portion of the battery can 5 is sealed with a top insulator 7 and a sealing body 8, whereby the lithium secondary battery 10 can be manufactured.

As a shape of the electrode group 4, for example, a columnar shape in which the cross-sectional shape is a circle, an ellipse, a rectangle, or a rectangle with rounded corners in a case where the electrode group 4 is cut in a direction perpendicular to a winding axis can be an exemplary example.

In addition, as the shape of the lithium secondary battery having such an electrode group 4, a shape that is specified by IEC60086, which is a standard for batteries specified by the International Electrotechnical Commission (IEC) or by JIS C 8500, can be adopted. For example, shapes such as a cylindrical shape and a square shape can be exemplary examples.

Furthermore, the lithium secondary battery is not limited to the above-described winding-type configuration, and may have a lamination-type configuration of a laminated structure in which the cathode, the separator, the anode, and the separator are repeatedly stacked. As the lamination-type lithium secondary battery, a so-called coin-type battery, button-type battery, or paper-type (or sheet-type) battery can be an exemplary example.

As the separator 1, the cathode 2, and the anode lead 31, a known material used in the configuration of the lithium secondary battery can be adopted.

As the anode 3, the aluminum anode according to the present embodiment described above can be adopted. That is, as the anode 3, an aluminum anode including an anode body containing aluminum as a material, in which a resistance value in a case where a lithium intercalation capacity is 1 mAh/cm² in a lithium intercalation reaction measured under the above-described measurement conditions is 6.5 kΩ·cm² or less, can be adopted.

In addition, as the anode 3, an aluminum anode including an anode body containing aluminum as a material and a coating film formed on a surface of the anode body, in which the coating film contains, as a material, any one selected from the group consisting of gold, carbon, and an alumina hydrate, can be adopted.

The electrolyte solution 6 is a nonaqueous electrolyte. As an organic solvent contained in the electrolyte solution, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, propyl propionate, and γ-butyrolactone; nitriles such as acetonitrile and butyronitrile; amides such as N,N-dimethylformamide and N,N-dimethylacetamide; carbamates such as 3-methyl-2-oxazolidone; and sulfur-containing compounds such as sulfolane, dimethyl sulfoxide, and 1,3-propanesultone, or those obtained by introducing a fluoro group into these organic solvents (those in which one or more of the hydrogen atoms of the organic solvent are substituted with a fluorine atom) can be used.

As the organic solvent, it is preferable to use a mixture of two or more of the organic solvents. Among these, a mixed solvent containing carbonates is preferable, and a mixed solvent of a cyclic carbonate and a non-cyclic carbonate or a mixed solvent of a cyclic carbonate and an ether is more preferable. As the mixed solvent of a cyclic carbonate and a non-cyclic carbonate, a mixed solvent containing ethylene carbonate, dimethyl carbonate, and ethyl methyl carbonate is preferable. The electrolyte solution using such a mixed solvent has many features such as a wide operating temperature range, difficulty in deterioration even in a case of charge and discharge at a high current rate, and difficulty in deterioration even in a case of long-term use.

As the electrolyte contained in the electrolyte solution, lithium salts such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (here, BOB refers to bis(oxalato)borate), LiFSI (here, FSI refers to bis(fluorosulfonyl)imide), lower aliphatic carboxylic acid lithium salts, and LiAlCl₄ can be exemplary examples, and a mixture of two or more of these may be used. Among these, as the electrolyte, at least one selected from the group consisting of LiPF₆, LiAsF₆, LiSbF₆, LiBF₄, LiCF₃SO₃, LiN(SO₂CF₃)₂, and LiC(SO₂CF₃)₃, which contain fluorine, is preferably used.

Furthermore, through the studies of the present inventors, it was found that LiBF₄ has an effect of suppressing the above-described formation of the film X compared with other electrolytes such as LiPF₆, in addition to lithium ion conductivity as the electrolyte. In a case where the electrolyte solution contains LiBF₄, BF₃ is released from LiBF₄ in the electrolyte solution. For example, in a case where ethylene carbonate (EC) is used as a solvent of the electrolyte solution, it is considered that the BF₃ protects an unshared electron pair of EC and suppresses decomposition of the electrolyte solution.

With the lithium secondary battery 10 as described above, cycle characteristics can be improved.

As described above, although preferred examples of the embodiments according to the present invention have been described with reference to the accompanying drawings, the present invention is not limited to such examples. The variety of shapes, combinations, and the like of the individual constituent members described in the above-described examples are examples, and a variety of modifications are permitted based on design requirements and the like without departing from the gist of the present invention.

The present invention includes the following aspects.
<1> An aluminum anode used in a nonaqueous electrolyte secondary battery, including:
an anode body containing aluminum as a material; and
a coating film formed on a surface of the anode body,
in which the coating film contains, as a material, any one selected from the group consisting of gold, carbon, and an alumina hydrate.
<2> An aluminum anode used in a nonaqueous electrolyte secondary battery, including:
an anode body containing aluminum as a material; and
a coating film formed on a surface of the anode body,
in which the coating film contains, as a material, any one selected from the group consisting of gold, carbon, and an alumina hydrate, and
a thickness of the coating film is 1 nm or more and 1 μm or less.
<3> An aluminum anode used in a nonaqueous electrolyte secondary battery, including:
an anode body containing aluminum as a material; and
a coating film formed on a surface of the anode body,
in which coating film contains carbon as a material, and
an oxygen content of the coating film is 0 mol % or more and 20 mol % or less.
<4> The aluminum anode according to any one of <1> to <3>,
in which the anode body contains aluminum and one or more metal elements selected from the group consisting of Si, Ge, Sn, Ag, Sb, Bi, In, Mn, and Mg, and
a content of the metal element with respect to a total amount of the anode body is 0.1% by mass or more and 8% by mass or less.
<5> The aluminum anode according to any one of <1> to <3>,
in which an average crystal grain size of an aluminum crystal grain, which is obtained from a scanning ion microscope image of a cross section of the anode body, is 1 μm or more and 200 μm or less.

### EXAMPLES

Hereinafter, the present invention will be described with reference to Examples, but the present invention is not limited thereto.

In the present example, measurements were performed as follows.

### (Resistance Value in Lithium Intercalation Reaction)

The resistance value in the lithium intercalation reaction was measured according to (Method for measuring resistance value of lithium intercalation reaction) described above.

### (Discharge Capacity Maintenance Rate)

The discharge capacity maintenance rate was measured according to (Method for measuring maintenance rate of discharge capacity) described above.

The thickness of the coating film was measured according to (Method for measuring thickness of coating film) described above.

### (Oxygen Content of Coating Film)

The oxygen content of the coating film was measured according to (Method for measuring oxygen content) described above.

### (Average Crystal Grain Size of Aluminum Crystal Grain)

The average crystal grain size of the aluminum crystal grain was measured according to (Method for measuring average crystal grain size) described above.

### (Thickness of Deposit)

The thickness of the deposit was measured according to (Method for measuring thickness of deposit) described above.

### (Content of Metal Element)

The content of the metal element was measured according to (Method for measuring content of metal element) described above.

### Example 1

### [Production of an Anode]

High-purity aluminum (purity: 99.99% by mass or more) and high-purity chemically produced silicon (purity: 99.999% by mass or more) were heated and held at 760° C. to obtain an aluminum-silicon molten alloy in which the silicon content was 1.0% by mass with respect to the total amount of aluminum and silicon.

Next, the molten alloy was cleaned by being held at a temperature of 740° C. for 2 hours under vacuum conditions of 50 Pa.

The molten alloy was cast in a cast iron mold (22 mm×150 mm×200 mm) dried at 150° C. to obtain an ingot.

Rolling was performed under the following conditions. After both surfaces of the ingot were subjected to scalping by 2 mm, cold rolling was performed from a thickness of 18 mm at a processing rate of 99.6%. The thickness of the obtained rolled material was 50 μm.

In a case where the rolled material was observed by a cross-sectional SIM (magnification: 2,000 times), crystal grains of aluminum were observed. In a case where the size of the crystal grains was observed for 50 crystal grains, the crystal grain size was within a range of 1 μm to 20 μm. It was confirmed that the average crystal grain size of the aluminum crystal grains was 200 μm or less.

High-purity aluminum-silicon alloy foil (thickness: 50 μm) having an aluminum purity of 99.999% and a silicon content of 1.0% by mass was cut out into a disk shape having a diameter of φ16 mm.

Gold was deposited on the disk-shaped rolled material to manufacture an aluminum anode of Example 1. The disk-shaped rolled material corresponds to the anode body in the aluminum anode.

The deposition conditions of gold were as follows. “Film thickness” corresponds to the thickness of the gold film to be formed.
Device: ion sputtering E-101 type; manufactured by Hitachi Naka Seiki Kabushiki Kaisha
Method: the disk-like rolled material was placed in a vacuum chamber, and gold was deposited by discharging between the target and the vacuum chamber.

### Conditions and the Like:

Target: Au—Pd (98:2) (manufactured by Hitachi High-Tech Corporation; model: 01E-1112; size: 300 mm×15 mm×0.25 mm)
Degree of vacuum: 15 to 20 Pa
Ion current: approximately 15 mA
Deposition time: 2 minutes
Film thickness: 100 Å (10 nm)

### [Production of a Cathode]

90 parts by mass of lithium cobalt oxide (product name: CELLSEED; manufactured by Nippon Chemical Industrial CO., LTD., average grain size (D50): 10 μm) as a cathode active material, 5 parts by mass of polyvinylidene fluoride (manufactured by Kureha Corporation) as a binder, and 5 parts by mass of acetylene black (product name: Denka Black, manufactured by Denka Company Limited) as a conductive material were mixed with each other, and 70 parts by mass of N-methyl-2-pyrrolidone was further mixed therewith, thereby producing an electrode mixture for a cathode.

The obtained electrode mixture was applied onto aluminum foil having a thickness of 15 μm, which was a current collector, by a doctor blade method. The applied electrode mixture was dried at 60° C. for 2 hours and further vacuum-dried at 150° C. for 10 hours to volatilize the N-methyl-2-pyrrolidone. The applied amount of the dried cathode active material was 21.5 mg/cm².

The obtained laminate of the electrode mixture layer and the current collector was rolled and cut out in a disk shape of φ14 mm, thereby producing a cathode, which was a laminate of the cathode mixture layer containing lithium cobalt oxide as a forming material and the current collector.

### [Production of an Electrolyte Solution]

An electrolyte solution was produced by dissolving LiPF₆ in a mixed solvent obtained by mixing ethylene carbonate (EC) and dimethyl carbonate (DMC) at EC:DMC=50:50 (volume ratio) with a ratio of 1 mol/L.

### [Manufacturing of a Lithium Secondary Battery]

A polyethylene porous separator was disposed between the anode and the cathode described above, and accommodated in a battery case (standard 2032), the above-described electrolyte solution was injected, and the battery case was sealed to produce a coin-type lithium secondary battery (lithium secondary battery including the aluminum anode of Example 1) having a diameter of 20 mm and a thickness of 3.2 mm.

### Example 2

An aluminum anode of Example 2 and a lithium secondary battery including the aluminum anode of Example 2 were produced in the same manner as in Example 1, except that carbon was deposited on the disk-shaped rolled material. The oxygen content of the formed carbon film was 5 mol %.

The deposition conditions of carbon were as follows. The length described in “Deposition amount” corresponds to a thickness of the carbon film to be formed.
Device: vacuum deposition device JEE-420; manufactured by JEOL Ltd.
Conditions: heated and deposited under a vacuum of 10⁻³ Pa or less
Deposition amount: 15 nm
Carbon source: carbon rod (5φ×100 mm); manufactured by JEOL Ltd.

### Example 3

An aluminum anode of Example 3 and a lithium secondary battery including the aluminum anode of Example 3 were produced in the same manner as in Example 1, except that the disk-shaped rolled material was immersed in hot water at 100° C. for 10 minutes to form an alumina hydrate.

### Example 4

An aluminum anode of Example 4 and a lithium secondary battery including the aluminum anode of Example 4 were produced in the same manner as in Example 1, except that the disk-shaped rolled material was washed with an alkali (5% by mass NaOH aqueous solution) at 60° C. for 30 seconds, washed with an acid (30% by mass HNO₃ aqueous solution) at 25° C. for 30 seconds, washed with water, and dried.

### Example 5

An aluminum anode of Example 5 and a lithium secondary battery including the aluminum anode of Example 5 were produced in the same manner as in Example 1, except that the disk-shaped rolled material was used as it was as the aluminum anode, and the electrolyte contained in the electrolyte solution was changed from LiPF₆ to LiBF₄.

### Example 6

A lithium secondary battery including the aluminum anode of Example 6 was produced in the same manner as in Example 2, except that the electrolyte contained in the electrolyte solution was changed from LiPF₆ to LiBF₄. The oxygen content of the formed carbon film was 5 mol %.

### Example 7

A lithium secondary battery including the aluminum anode of Example 7 was produced in the same manner as in Example 3, except that the electrolyte contained in the electrolyte solution was changed from LiPF₆ to LiBF₄.

### Example 8

An aluminum anode of Example 8 and a lithium secondary battery including the aluminum anode of Example 8 were produced in the same manner as in Example 6, except that carbon with a thickness of 5 nm was deposited on the disk-shaped rolled material. The oxygen content of the formed carbon film was 5 mol %.

### Example 9

An aluminum anode of Example 9 and a lithium secondary battery including the aluminum anode of Example 9 were produced in the same manner as in Example 6, except that carbon with a thickness of 30 nm was deposited on the disk-shaped rolled material. The oxygen content of the formed carbon film was 5 mol %.

### Example 10

An aluminum anode of Example 10 and a lithium secondary battery including the aluminum anode of Example 10 were produced in the same manner as in Example 3, except that the disk-shaped rolled material was immersed in hot water at 60° C. for 5 minutes to form an alumina hydrate.

### Example 11

An aluminum anode of Example 11 and a lithium secondary battery including the aluminum anode of Example 11 were produced in the same manner as in Example 3, except that the disk-shaped rolled material was immersed in hot water at 50° C. for 30 minutes to form an alumina hydrate.

### Example 12

An aluminum anode of Example 12 and a lithium secondary battery including the aluminum anode of Example 12 were produced in the same manner as in Example 3, except that the disk-shaped rolled material was immersed in hot water at 60° C. for 5 minutes to form an alumina hydrate, and the electrolyte contained in the electrolyte solution was changed from LiPF₆ to LiBF₄.

### Example 13

An aluminum anode of Example 13 and a lithium secondary battery including the aluminum anode of Example 13 were produced in the same manner as in Example 3, except that the disk-shaped rolled material was immersed in hot water at 50° C. for 30 minutes to form an alumina hydrate, and the electrolyte contained in the electrolyte solution was changed from LiPF₆ to LiBF₄.

### Comparative Example 1

An aluminum anode of Comparative Example 1 and a lithium secondary battery including the aluminum anode of Comparative Example 1 were produced in the same manner as in Example 1, except that the disk-shaped rolled material was used as it was as the aluminum anode.

The evaluation results are shown in Table 1. In the column of “Surface treatment” in Table 1, the description in parentheses after “Carbon” indicates the film thickness of the carbon film. Similarly, the description in parentheses after “Alumina hydrate” indicates forming conditions (immersion conditions of the disk-shaped rolled material in hot water) in a case of forming the alumina hydrate.

TABLE 1

| | | | | | Number of |
|---|---|---|---|---|---|
| | Formulation | | | Resistance | cycles with |
| | of anode | Surface | | value | maintenance |
| | body | treatment | Electrolyte | (kΩ · cm²) | rate of 80% |
| Example 1 | 4N Al | Gold | LiPF₆ | 6.0 | 112 |
| Example 2 | Si 1% AR | Carbon (15 nm) | LiPF₆ | 6.3 | 114 |
| Example 3 | | Alumina hydrate | LiPF₆ | 6.1 | 120 |
| | | (100° C. - 10 min) | | | |
| Example 4 | | Acid/alkali | LiPF₆ | 6.2 | 105 |
| | | treatment | | | |
| Example 5 | | None | LiBF₄ | 6.1 | 139 |
| Example 6 | | Carbon (15 nm) | LiBF₄ | 6.2 | 181 |
| Example 7 | | Alumina hydrate | LiBF₄ | 6.2 | 125 |
| | | (100° C. - 10 min) | | | |
| Example 8 | | Carbon (5 nm) | LiBF₄ | 6.2 | 137 |
| Example 9 | | Carbon (30 nm) | LiBF₄ | 6.2 | 138 |
| Example 10 | | Alumina hydrate | LiPF₆ | 6.3 | 108 |
| | | (60° C. - 5 min) | | | |
| Example 11 | | Alumina hydrate | LiPF₆ | 6.4 | 117 |
| | | (50° C. - 30 min) | | | |
| Example 12 | | Alumina hydrate | LiBF₄ | 6.0 | 141 |
| | | (60° C. - 5 min) | | | |
| Example 13 | | Alumina hydrate | LiBF₄ | 6.0 | 132 |
| | | (50° C. - 30 min) | | | |
| Comparative | | None | LiPF₆ | 6.6 | 100 |
| Example 1 | | | | | |

As a result of the evaluation, in any of Examples 1 to 13, the resistance value in the lithium intercalation reaction was lower than the result of Comparative Example 1, which suggested that the formation of the film X using the decomposition product of the electrolyte was suppressed. In addition, the cycle characteristics of Examples 1 to 13 were all improved compared with the cycle characteristics of Comparative Example 1.

In Examples 6 to 9, 12, and 13, it was found that, by the combination of the aluminum anode obtained by coating the anode body with carbon or alumina hydrate and the electrolyte solution in which LiBF₄ was adopted as the electrolyte, excellent cycle characteristics could be achieved. It is considered that each of the effect of the suppression of the adhesion of the film X by the surface modification of the aluminum anode and the effect of the suppression of the decomposition of the electrolyte by LiBF₄ is exhibited. Therefore, even in Examples 1, 4, and 5, by the combination of another aluminum anode and the electrolyte solution in which LiBF₄ was adopted as the electrolyte, excellent cycle characteristics could be expected.

From the above-described results, it was found that the present invention is useful.

### REFERENCE SIGNS LIST

2, 60: Cathode
3, 40A, 40B, 50: Aluminum anode (anode)
6, 70: Nonaqueous electrolyte (electrolyte)
10, 100: Lithium secondary battery (nonaqueous electrolyte secondary battery)
41: Anode body
42: Coating film

1. An aluminum anode used in a nonaqueous electrolyte secondary battery, comprising:
an anode body containing aluminum as a material,
wherein a resistance value in a case where a lithium intercalation capacity is 1 mAh/cm² in a lithium intercalation reaction measured under the following measurement conditions is 6.5 kΩ·cm² or less,
(measurement conditions)
current density: 0.6 mA/cm²
cathode: LiCoO₂
electrolyte: 1 mol/L LiPF₆ solution (a mixed solvent of ethylene carbonate:dimethyl carbonate=1:1 (volume ratio))
measurement temperature: 25° C.
C-rate: 0.2 C.

2. The aluminum anode according to claim 1, further comprising:
a coating film formed on a surface of the anode body,
wherein the coating film contains, as a material, any one selected from the group consisting of gold, carbon, and an alumina hydrate.

3. The aluminum anode according to claim 2,
wherein a thickness of the coating film is 1 m or less.

4. The aluminum anode according to claim 2,
wherein the coating film contains the carbon as a material, and
an oxygen content of the coating film is 20 mol % or less.

5. The aluminum anode according to claim 1,
wherein the anode body is a rolled material, and
in FT-IR analysis of a surface of the anode body, a rolling oil is equal to or lower than a detection limit.

6. The aluminum anode according to claim 1,
wherein a thickness of a deposit of the electrolyte, which is formed on a surface of the aluminum anode after the lithium intercalation reaction is carried out, is 2 m or less.

7. The aluminum anode according to claim 1,
wherein the anode body contains the aluminum and one or more metal elements selected from the group consisting of Si, Ge, Sn, Ag, Sb, Bi, In, Mn, and Mg, and
a content of the metal element with respect to a total amount of the anode body is 0.1% by mass or more and 8% by mass or less.

8. The aluminum anode according to claim 1,
wherein an average crystal grain size of an aluminum crystal grain, which is obtained from a scanning ion microscope image of a cross section of the anode body, is 200 m or less.

9. A nonaqueous electrolyte secondary battery, comprising:
a cathode;
the aluminum anode according to claim 1; and
a nonaqueous electrolyte.

10. The nonaqueous electrolyte secondary battery according to claim 9,
wherein the nonaqueous electrolyte contains LiBF₄.

11. A nonaqueous electrolyte secondary battery, comprising:
a cathode;
an aluminum anode; and
a nonaqueous electrolyte containing LiBF₄,
wherein, in the aluminum anode, a resistance value in a lithium intercalation reaction measured under the following measurement conditions is 6.5 kΩ·cm² or less,
(measurement conditions)
lithium intercalation capacity: 1 mAh/cm²
current density: 0.6 mA/cm²
cathode: LiCoO₂
measurement temperature: 25° C.
C-rate: 0.2 C.
